(19) United States
(12) Patent Application Publication
(10) Pub. No.: US 2020/0158435 A1
(43) Pub. Date: May 21, 2020

(54) FACILITY FOR LONGITUDINAL SEALING UP WIND BOXES IN TRAVELLING GRATE FACILITIES

(71) Applicant: OUTOTEC (FINLAND) OY, Espoo (FI)

(72) Inventors: Basavan Goud SALAGUNDI, Oberursel (DE); Maycon ATHAYDE, Oberursel (DE)

(21) Appl. No.: 16/752,764

(22) Filed: Jan. 27, 2020

Related U.S. Application Data
(63) Continuation of application No. PCT/EP2017/069662, filed on Aug. 3, 2017.

(51) Int. Cl. F27B 21/06; F27D 3/12; F27D 99/00; C22B 1/02

(52) U.S. Cl. CPC F27B 21/06; C22B 1/02; F27D 99/0073; F27D 3/123

(57) ABSTRACT

A device for thermal treatment of bulk material, includes a travelling grate chain revolving in the direction of movement including an endless travelling grate with movable links. The travelling grate chain features a plurality of pallet cars, and grate rods arranged on crossbars. Further, wind boxes are arranged such that gas flows through the pallet cars and their grate rods from or into the wind boxes. At each pallet car at least one sealing blade is mounted in parallel to the moving direction and flush with the pallet car, whereby a sealing box is in parallel to the moving direction. A liquid medium is filled into at least one sealing box, such that the sealing blade is immersed in the liquid.

The invention relates to a facility for thermal treatment of bulk material, comprising a travelling grate chain being capable of revolving in the direction of movement consisting of an endless travelling grate with movable pallet cars, each consisting of a frame with crossbars and end pieces and grate rods arranged on crossbars and at least two wind boxes which are arranged such that gas flows through the grate being built by the grate rods from the or into the at least two wind boxes. The invention also relates to a method for thermal treatment of bulk material in said apparatus.

In pellet burning or sintering machines the bulk material to be treated, such as for example iron ore, iron oxides, manganese ore or also zinc ore, is loaded onto pallet cars. These pallet cars consist of a frame being provided with wheels and consisting of end pieces and crossbars, and grate rods arranged between the crossbars. A plurality of such pallet cars forms an endless pallet car chain which is also referred to as travelling grate.

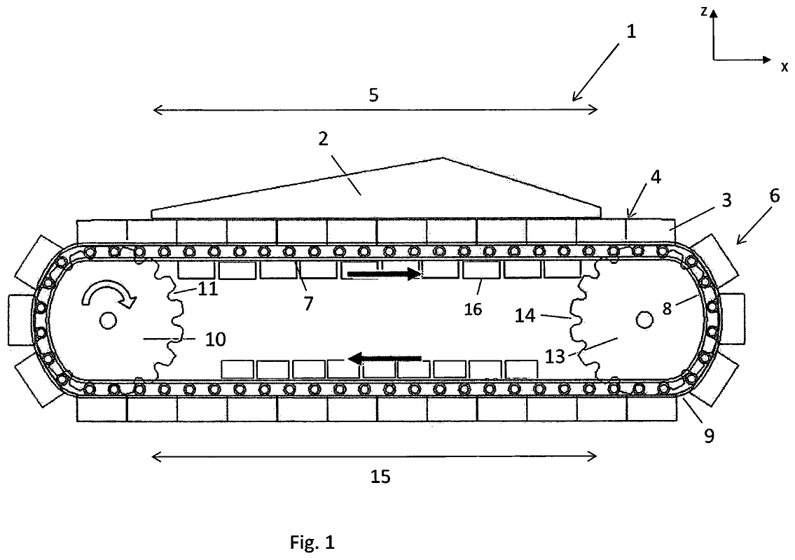

In FIG. 1, for example, a pellet induration machine 1 for burning pellets of iron ore, Mn ore Or Zn ore is shown, wherein here the present invention has been employed. At a feeder station before a hood 2 the bulk material is loaded onto pallet cars 3 forming an endless pallet car chain which is referred to as travelling grate 4. Under the hood 2 the bulk material being transported on the pallet cars 3 passes through a number of thermal treatment stations. In detail, these stations are

1. the charging zone,
2. the first drying zone,
3. the second drying zone,
4. the prefiring zone,
5. the burning zone,
6. the afterfiring zone,
7. the cooling zone and
8. the exit zone.

In these zones the pallet cars are charged with the material, the bulk material is dried, preheated, fired and subsequently cooled again. The drive of the travelling grate 4 is effected via a driving or elevating wheels 10 being designed as a gear wheel and engaging with its tooth gaps (recesses 11) at the wheels 7 of the pallet cars 3.

After passing through the hood 2 the pallet cars 3 of the travelling grate 4 reach a discharge station which is assigned to a lowering or driven wheel 13 of the continuous conveyer 6. Like in the case of the elevating wheel 10 at the descending wheel 13 tooth gaps 14 of the output gear wheel engage with the rollers 7 of the pallet cars 3. The pallet cars 3 are tilted so that their load is discharged by gravitational force. Since the pallet cars 3 are guided by the outer rail guide 9, they itself do not fall down, but will be returned back to the elevating wheel 10 upside down in a lower run 15 of the continuous conveyer 6. Below the hood 2 wind boxes 16 are arranged which allow a controlled gas flow. In the region of the upper run 5 the pallet cars 3 travel along between the above lying hood 2 and the below lying wind boxes 16 without colliding with the components of the hood 2 or the wind boxes 16.

During normal operation the travelling grate 4 revolves on the continuous conveyer 6 in an endless manner and transports the bulk material to be treated through the treatment stations under the hood 2, before it is discharged at the discharge station and is processed further in a manner which is not described in detail here.

In this process, the energy efficiency is a great concern of pelletizing operator as the process can consumes as much as 250 Mcal/ton, which may represents one third of the variable cost. Despite of the correct gas flow design and fan efficiency, the furnace needs to be effective sealed in order to have the energy consumption & Production closer to the designed at pot grate and heat balance.

As already mentioned, in the two drying zones, the pre-firing zone, the burning zone, the after-firing zone and the cooling zone the bulk material contained in the pallet cars is thermally treated by letting flow hot or cold gas either from the wind box through the bulk bed in the pallet car into the hood or from the hood through the bulk bed in the pallet car into the wind box. Therefore, wind box, hood and the moving pallet cars in this section have to be sealed efficiently.

On the one hand, said sealing takes place between the wind boxes due to pressure changes between them. Such pressure changes are caused by a change between no flow in one wind box and any flow in the adjacent wind box or between two wind boxes with different orientated flows. Since these changes of the direction of the flow each are caused by different pressures in the assigned wind boxes and these wind boxes directly lay side by side, it is important to seal up the passage between the adjacent wind boxes for avoiding that here unintentional gas flows directly from the wind box with the higher pressure into the wind box with the lower pressure occur.

On the other hand the section of wind boxes, hood(s) and the moving pallet cars have to be sealed against the ambient. In the actual process the pallet cars move over a seal bar of the wind box arranged in the moving direction. These seal bar are grease lubricated to minimize the direct contact and minimize wear and tear. Both seal bars are made up of special alloy material (wear resistant) and are grease lubricated to minimize the direct contact and minimize wear and tear.

However, leakages often occur due to deformations caused by high temperature differences in the induration machine as well as normal wearing due friction and dust presence. Moreover, these seals bars are consumables and high maintenance is necessary to replace them, especially since the complete induration machine has to be shut down.

Therefore, it is the object of the invention is to improve the sealing for long retention time and to avoid shut-downs of the plant due to maintenance work.

This object is solved by a facility with the features of claim 1.

The facility according to the present invention comprises a travelling grate chain being capable of revolving in the direction of movement consisting of an endless travelling grate with movable links. Furthermore, it comprises the pallet cars each consisting of a frame with wheels and grate rods arranged on crossbars. Furthermore, the facility comprises at least two wind boxes which are arranged one after the other in the direction of movement and which are also arranged such that gas can flow through the pallet cars from or into at least one of the wind boxes.

According to the present invention, at the pallets cars at least one sealing blade each (preferably both side of the pallet car) is mounted in parallel to the moving direction and flush with the pallet car. At least two sealing box (One on either side of the furnace/machine) is foreseen in at least one section of the travelling grate in parallel to the moving direction which is designed for filing a liquid medium into. The sealing box is arranged such that during operation the sealing blade is immersed in the liquid.

Instead of the traditional slide track, the invention uses a sealing blade on the same position of the sealing bar installed on the pallet car. Thereby, the invention facilitates an effective sealing.

Further, the invention has the advantage of minimum lubricant to avoid contact among metallic parts which leads to cost reduction. Moreover, a complete sealing can be ensured over the whole furnace and the whole durability so thermal energy consumption is maintained as per original design and heat balance and further also significantly reduces the possible energy losses. In addition, thereby an unscheduled stop of the facility due to leakage is avoided.

In a preferred embodiment, the sealing box is formed as a u-profile. Therefore, standard units can be used.

It is preferred to use low cost liquids (Such as water etc.) since it is easy available, cheap and incombustible.

In typical induration furnaces, this sealing blade shows preferably a length (orthogonal to the moving direction) of max. 800 mm to 900 mm which going to match the room available at the actual support bin of the slide track replaced by the sealing box. Typically, the pressure at the wind box goes maximum around +/−75 to 80 mbar which means for water as liquid the liquid column is always bellow 800 mm. The box thickness is preferably 50-60 mm to compensate car misalignments.

More generally speaking the sealing box has a height being higher than the sum of the water level and A, whereby A is defined as

$$A = \frac{Δ p}{ρ * g}$$

with Δₚ defined as the pressure difference between the pressure in a wind box and the ambient pressure (in Pa), ρ is the fluid density (kg/m³) and g is gravitational constant (m/s²). So it is ensured that the liquid does not overflow.

Also, it is preferred that the sealing box is designed such that the water level and ambient conditions has a height being higher than the difference of the water level minus A, whereby A is defined as

$$A = \frac{Δ p}{ρ * g}$$

with Δp defined as the pressure difference between the pressure in a wind box and the ambient pressure (in Pa), ρ is the fluid density (kg/m³) and g is gravitational constant (m/s²). Thereby a falling dry of the sealing box is avoided.

Preferably, each sealing blades is as long as the pallet car (in moving direction) it is mounted with. So, the number of gaps and, therefore, potential leakages is minimized.

Alternatively, at least two sealing blades are arranged in series without any gap, whereby the overall closely arrangement is as long as the pallet car (in moving direction). So the handling of each sealing blades is reduced to lower weight and size.

In another preferred embodiment, the sealing blades are bolted at the frames of the pellet cars, preferably where the slide tracks are located. Therefore, they are easily removable. However, other fixings are also possible. Independent from the fixing, maintenance is much easier since single pallet cars can be taken out and the sealing blades can be changed. Using bolting, this changing can be done very fast and easy.

It is also preferred that the at least one sealing box extends over at least two wind boxes to seal as longer distance. It is even more preferred that one sealing box extends over all wind boxes. Therefore, only one entry zone and one exit zone is necessary while the whole furnace area is sealed along the moving direction.

For sealing the induration machine on both sides, two sealing boxes are positioned opposite and parallel to each other.

Preferably, the sealing blades immerse into the liquid in the sealing box in an entry zone and exit from it in an exit zone, whereby in the entry zone and the exit zone sealing leaves are foreseen which can be pressed against the sealing blades. So, the sealing leaves act as barriers for liquid at the entry and the exit zone. Thereby the sealing liquid is retained and it is avoided that liquid is poured out of the sealing box, or, in other words, the leaves press the main blade, multiple leaves going to ensure less or no liquid leakage.

In a preferred embodiment of the idea described above, the sealing leaves are pressed against the sealing blades with springs.

Moreover, the sealing leaves are preferably made of soft material at the tip and body made out of special steel. The sealing leaves set are pressed against the sealing blade by springs with minimum the 10 kpa, to avoid liquid leakage.

In a preferred embodiment of the invention, the facility features a pump, a supply conduit to the at least one sealing box and a discharge conduit from the at least one sealing box for the liquid. So, the liquid can be recycled and cooled, or even worse, evaporating of the liquid is avoided. Moreover, fresh liquid can be-refilled. It is to use a buffer system.

The invention also comprises a method for thermal treatment of bulk material with the features of claim 15.

In such a method a travelling grate chain revolves in a direction of movement, wherein the travelling grate chain contains a plurality of pallet cars, each consisting of two end pieces with wheels and grate rods arranged on at least two crossbars and at least two wind boxes which are arranged one after the other so that in at least one wind box gas flows downwards or upwards through the pallet cars.

The different pressure between the wind box and the ambient is sealed with sealing blades immersing into a liquid filled into at least one sealing box. The sealing blades are mounted at each pallet car of the travelling grate in parallel to the moving direction and flush with the pallet car. The at least one set of sealing box is foreseen in at least one section of the travelling grate in parallel to the moving direction.

Further features, advantages and possible applications of the invention follow from the description of the figures below. Here, all described and/or depicted features form on its own or in arbitrary combination the subject matter of the invention, independently from their summary in the patent claims or their back references.

Shown are in:

FIG. 1 the construction of a travelling grate,

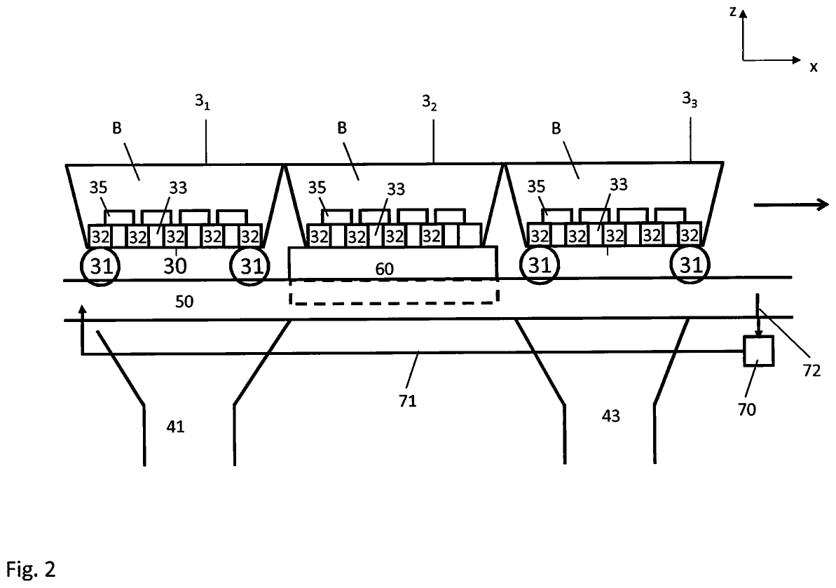

FIG. 2 the design according to the present invention of pallet cars as a section of a travelling grate chain in the region of two wind boxes,

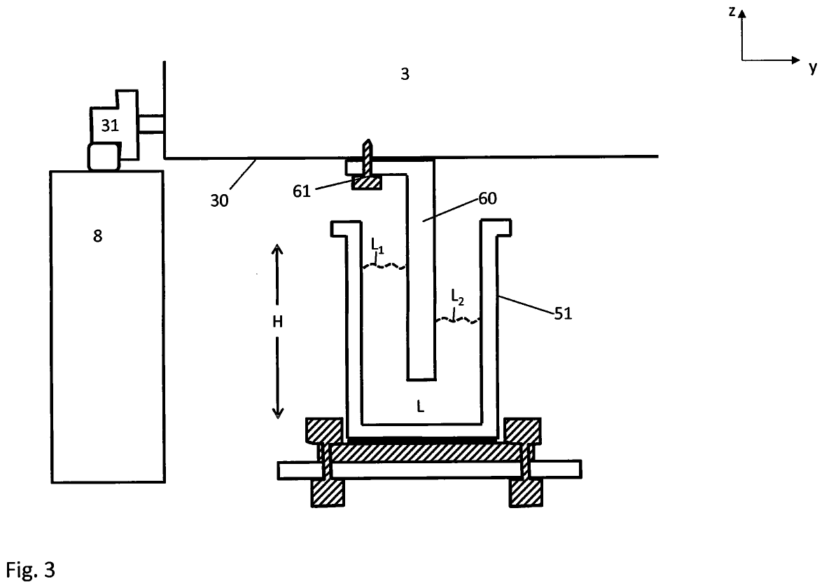

FIG. 3 the design according to the present invention of sealing blade and sealing box and

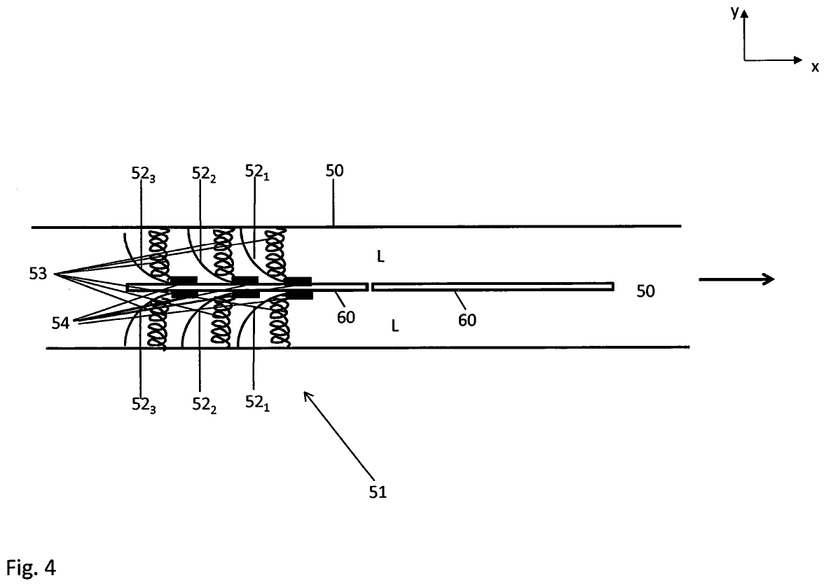

FIG. 4 the design according to the present invention of an entry or an exit zone of a sealing box.

FIG. 1 has already been explained in detail and shows in principle the arrangement of a travelling grate as is also the basis of the present invention.

FIG. 2 shows the section of a travelling grate chain 1 which is depicted by way of example with two adjacent wind boxes 41 and 43 and three pallet cars 31, 32 and 33. The three pallet cars 31, 32 and 33 each comprise a frame 30 which consists of two end pieces 33 extending in its largest extent in x-direction and which contains preferably five crossbars 32 being arranged across thereto and being fixed at the end pieces 33 and extending in their largest extent in y-direction. On these crossbars 32 in turn the grate rods 35 are arranged which gather the filling B of the pallet car.

The three pallet cars 31, 32 and 33 pass the wind box 41 and the wind box 43. Extending over both wind boxes 41 and 43 a sealing box 50 is arranged. The sealing box 50 is filled with liquid.

At the same time the pallet cars 31, 32 and 33 each comprises a sealing blade 60, which is shown only for pallet car 32. Sealing blades 60 are mounted flush, e.g. at the frame of the pallet cars 31, 32 and 33, preferably at the sealing tracks, and each extend over the whole extent of the pallet cars 31, 32 and 33 in x-direction. As shown, the sealing blades 60 immerse into the sealing box 50.

Via pump 70 and supply conduit 71, liquid can be re-filled into sealing box 50 while it is withdrawn via discharging conduit 72. Thereby, liquid can be recirculated to avoid overheating. It is also possible to re-fill liquid and/or to use a buffer system (not shown).

FIG. 3 shows the sealing box 50 in more detail. The sealing blade 60 is mounted on the frame 30 of pellet car 3 (only indicated in FIG. 3), whereby the sealing blade 60 is formed as an L-profile. Its shorter side is fixed with screw 61 on frame 30 of the pellet car 32.

Sealing box 50 with height H is filled with liquid L with two levels L₁ and L₂. Level L₁ is found next to the ambient while Level L₂ is developed on the inside of the furnace, preferably sealed in moving direction by two sealing boxes 60 and orthogonal to the moving direction by sealing bars also mounted on the pallet cars 3.

FIG. 4 shows an entry or an exit zone 51 of a sealing box 50 in x-y perspective. Its assembly is composed by multiples sealing leaves 52₁, 52₂, and 52₃. Preferably these sealing leaves 52₁, 52₂, and 52₃ are arranged symmetrical to each other. Also, it is preferred that the sealing leaves 52₁, 52₂, and 52₃ features holder polymers 54 on the side which can be pressed on sealing blade 60-

The sealing leaves 52₁, 52₂, and 52₃ are made out soft material of flexible steel pressed against the sealing bar, preferably using springs 53. So they retain the sealing liquid L and avoid that it is poured out of the sealing box 50, since they act as barriers for the liquid at the ending and entrance of the plant length by being pressed against sealing blade 60

### LIST OF REFERENCE SIGNS

1 pellet induration machine
2 hood
3 pallet car
4 travelling grate, pallet car chain
5 upper run
6 continuous conveyer
7 track roller of the pallet car
8 inner rail guide
9 outer rain guide
10 elevating or driving wheel
11 tooth gap
13 lowering or driven wheel
14 tooth gap
15 lower run
30 pallet car frame
31 roller
32 crossbar
33 end piece
34 side wall
35 grate rod
41 first wind box
43 second wind box
50 sealing box
51 exit or entry zone of the sealing box
52₁, 52₂, 52₃ sealing leaf
53 spring
54 holder polymer
60 sealing blade
61 screw
70 pump
71 supply conduit
72 discharge conduit
H height of the sealing box
L liquid
L₁, L₂ liquid level

1-15. (canceled)

16. A device for thermal treatment of bulk material, comprising a travelling grate chain configured to resolve in a direction of movement including an endless travelling grate with movable links, a plurality of pallet cars, each including a frame with end pieces, on which carrying wheels are fixed, and grate rods arranged on crossbars, and with wind boxes which are arranged such that from at least one wind box gas flows through the pallet cars and their grate rods from or into the wind boxes, wherein at each pallet car of the travelling grate at least one sealing blade each is mounted in parallel to the moving direction and flush with the pallet car, that at least one sealing box is foreseen in at least one section of the travelling grate in parallel to the moving direction, and that a liquid medium can be filled into the at least one sealing box, wherein the sealing box is arranged such that the sealing blade is immersed in the liquid during operation wherein the sealing blade immerses into the liquid in the sealing box in an entry zone and exits from it in an exit zone, whereby the entry and the exit zone feature sealing leaves which can be pressed against the sealing blade with springs.

17. The device according to claim 16, wherein the sealing box has a u-Profile.

18. The device according to claim 16, wherein the liquid is water or combinations of two or three different liquids.

19. The device according to claim 18, wherein the sealing box has a height, which is higher than the sum of the liquid level and A, whereby A is defined as
$$A = \frac{Δ p}{ρ * g}$$
with Δp defined as the pressure difference between the pressure in a wind box and the ambient pressure (in Pa), ρ is the fluid density (kg/m3) and g is gravitational constant (m/s2).

20. The device according to claim 18, wherein the sealing box is designed such that the liquid level and ambient conditions has a height, which is higher than the difference of the liquid level minus A, whereby A is defined as
$$A = \frac{Δ p}{ρ * g}$$
with Δp defined as the pressure difference between the pressure in a wind box and the ambient pressure (in Pa), ρ is the fluid density (kg/m3) and g is gravitational constant (m/s2).

21. The device according to claim 16, wherein the sealing blade extends over the whole length of a pellet car from one end piece to the other.

22. The device according to claim 16, wherein the sealing blade is bolted at the frames of the pellet cars.

23. The device according to claim 16, wherein the sealing box extends over at least two wind boxes.

24. The device according to claim 16, wherein the sealing box extend over all wind boxes.

25. The device according to claim 16, wherein two sealing boxes are positioned opposite and parallel to each other.

26. The device according to claim 16, wherein the sealing leaves are made of flexible steel.

27. The device according to claim 16, wherein a pump, a supply conduit to the at least one sealing box and a discharge conduit from the at least one sealing box for the liquid is foreseen.

28. A method for thermal treatment of bulk material, comprising a travelling grate chain revolving in the direction of movement comprising an endless travelling grate with movable links, a plurality of pallet cars, each including a frame with wheels and grate rods arranged on crossbars and wind boxes which are arranged such that gas flows through the pallet cars and their grate rods from or into wind boxes, wherein at least one sealing blade of which is mounted at a pallet car of the travelling grate in parallel to the moving direction and flush with the pallet car is immersing into a liquid filled in at least one sealing box, whereby the sealing box is foreseen in at least one section of the travelling grate in parallel to the moving direction wherein the sealing blade immerses into the liquid in the sealing box in an entry zone and exits from it in an exit zone, whereby the entry and the exit zone feature sealing leaves which can be pressed against the sealing blade with springs.
